(19) United States
(12) Patent Application Publication
(10) Pub. No.: US 2021/0256003 A1
(43) Pub. Date: Aug. 19, 2021

(54) INFORMATION PROCESSING SYSTEM AND CONTROL METHOD

(71) Applicant: CANON KABUSHIKI KAISHA, Tokyo (JP)

(72) Inventor: Tsutomu Inose, Kanagawa (JP)

(21) Appl. No.: 17/167,741

(22) Filed: Feb. 4, 2021

(30) Foreign Application Priority Data
Feb. 14, 2020 (JP) 2020-023485

(51) Int. Cl. G06F 16/21

(52) U.S. Cl. CPC G06F 16/217

(57) ABSTRACT

An information processing system that includes an acceptance unit configured to accept an event from an external apparatus and a database to which a processing result of the accepted event is to be written, the information processing system includes a memory storing instructions, and a processor executing the instructions causing the information processing system to check an operation rate of the database upon acceptance of the event from the external apparatus, determine whether to process the event accepted from the external apparatus based on the checked operation rate of the database, and activate a processing unit to execute the processing of the event in a case where it is determined to process the accepted event, wherein activation of a plurality of the processing units is executable, and wherein the activated processing unit executes the processing of the event and writes the processing result of the event to the database.

### BACKGROUND

### Field of the Disclosure

The present disclosure relates to an information processing system using a cloud service, and a control method.

### Description of the Related Art

When a system is constructed using the cloud, the cloud provides services with roughly two different qualities. One is a service that is unique to the cloud and allows resources (resources for processing data) to be procured and utilized on demand. In the service, processing performance is maintained by increasing or decreasing program execution environments on demand depending on the amount of processing to be performed. By decreasing the number of execution environments when the amount of processing decreases, unnecessary costs can be eliminated. However, the processing capability can be increased by increasing the number of execution environments (scale-out) only for the following services:
A service in which maintaining a state is unnecessary and processing is completed each time the processing is performed
A service in which no transaction management is required for data storage

Examples of these services in the cloud include a service of providing a virtual server that executes applications created on the premise of scaling-out or providing a server-less execution environment, and a data storage service in the key value store (KVS) format.

Another service provided by the cloud is a service in a commonly practiced form even outside the cloud and having resources that remain unchanged for a certain period of time. In this service, when the amount of processing or data increases, the specifications (memory, central processing unit (CPU) power, etc.) of the server (including the case of a virtual server) are increased. That is, support is provided by a scale-up. However, to provide support by a scale-up, it is necessary to secure resources in accordance with the expected peak of processing, so the cost will be wasted except during the peak time. Further, in a case where a request for processing beyond the expected peak comes in, the scale-up cannot be carried out on demand, which may result in stopping of the processing or occurrence of an abnormality, for example. Examples of these services include a service with a server (including a virtual server) that executes applications created without assuming a scale-out, and a relational database service.

Conventionally, in the latter service, processing of queuing or rejecting a request for processing in accordance with the priority of events accepted by the server and the state of the server (Japanese Unexamined Patent Application Publication (Translation of PCT Application) No. 2007-529080) has been performed.

However, in a case where a service is set up on the cloud, a system may be constructed by combining parts that can be scaled out and parts that cannot be scaled out. The conventional technique has not provided a solution for such a system. In a system including a combination of parts that can be scaled out and parts that cannot be scaled out, while an event is accepted and processed in a service that can be scaled out, a request for processing may be made to a database that cannot be scaled out. Specifically, the processing unit that processes the event writes the processing result of the event to the database. If the number of events accepted within a predetermined time is small, writing to the database will be performed without any problem. However, if the number of events accepted at a predetermined time is large, the processing capability of the database may be exceeded so that writing to the database may not be performed normally.

### SUMMARY

According to embodiments of the present disclosure, an information processing system that includes an acceptance unit configured to accept an event from an external apparatus and a database to which a processing result of the accepted event is to be written, the information processing system includes one or more processors, and at least one memory storing instructions, which when executed by the one or more processors, cause the information processing system to check an operation rate of the database upon acceptance of the event from the external apparatus, determine whether to process the event accepted from the external apparatus based on the checked operation rate of the database, and activate a processing unit to execute the processing of the event in a case where it is determined to process the accepted event, wherein activation of a plurality of the processing units is executable, and wherein the activated processing unit executes the processing of the event and writes the processing result of the event to the database.

Further features of the present disclosure will become apparent from the following description of exemplary embodiments with reference to the attached drawings.

### BRIEF DESCRIPTION OF THE DRAWINGS

FIG. 1 is a block diagram of an overall system configuration.

FIG. 2 is a device block diagram.

FIG. 3 is a block diagram of modules in an information processing system.

FIG. 4 is a processing flowchart.

FIG. 5 is a block diagram of the information processing system.

FIGS. 6A and 6B are processing flowcharts.

FIG. 7 is a processing flowchart.

FIGS. 8A, 8B, 8C, and 8D are tables illustrating data examples.

### DESCRIPTION OF THE EMBODIMENTS

Hereinafter, the present disclosure will be described in detail based on preferred exemplary embodiments, with reference to the accompanying drawings. The configurations shown in relation to the following exemplary embodiments are mere examples, and the present disclosure is not limited to the illustrated configurations.

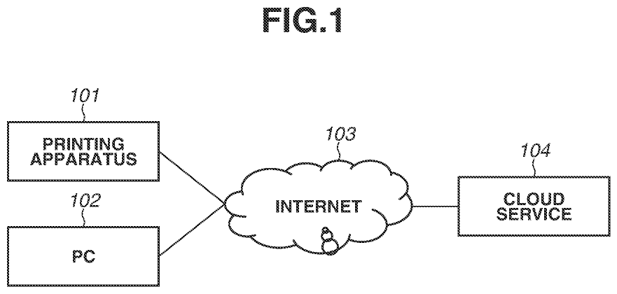

A first exemplary embodiment will be described. FIG. 1 is an overall block diagram illustrating a system according to a preferred exemplary embodiment of the present disclosure.

The outline of the information processing system will be described below with reference to FIG. 1.

A printing apparatus 101 is an apparatus that performs printing. A personal computer (PC) 102 is an external apparatus such as a personal computer operated by a user using a browser. A cloud service 104 is connected to the printing apparatus 101 and the PC 102 via the Internet 103. The cloud service 104 receives an event such as a use state or a trouble state of the printing apparatus issued by the printing apparatus 101 and performs predetermined processing. On the cloud service 104, the user of the PC 102 uses a browser in the PC 102 to issue a registration/update/deletion event of the printing apparatus 101 and a viewing event of use state or trouble state of the printing apparatus 101, and receives the result. There may be a plurality of printing apparatuses 101 and PCs 102 in the system.

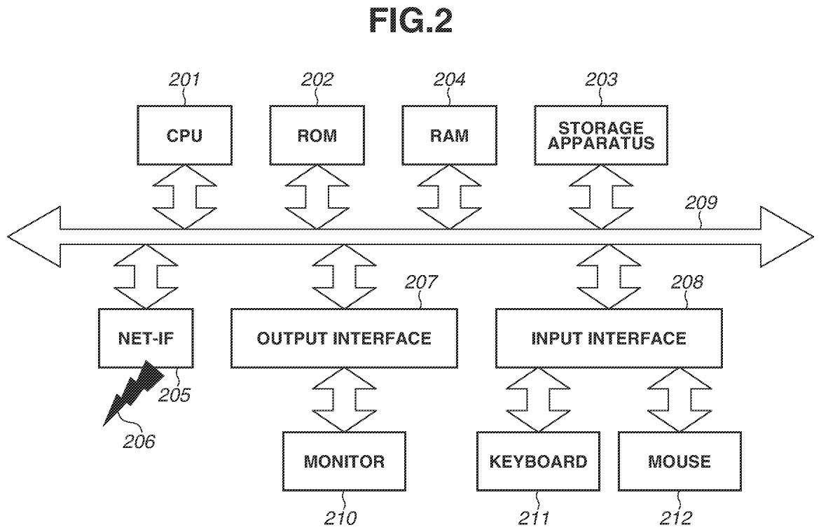

FIG. 2 is a block diagram illustrating a schematic configuration of an apparatus that operates on a cloud service according to the preferred exemplary embodiment of the present disclosure.

Referring to FIG. 2, a central processing unit (CPU) 201 controls each device connected to the CPU device based on control programs stored in a read only memory (ROM) 202 and a storage apparatus 203. The ROM 202 holds various control programs and data. A random access memory (RAM) 204 has a work area for the CPU 201, a save area for data at the time of error handling, a load area for control programs, and the like. The storage apparatus 203 stores various control programs and various data. A network interface 205 can communicate with other information devices and the like via a network 206. The control programs can be provided to the CPU 201 from the ROM 202 and the storage apparatus 203, or from another information device or the like via the network 206. An input interface 208 is an interface with a device that inputs data to the apparatus. An output interface 207 is an interface for outputting data generated by the apparatus, data held by the apparatus, and data supplied via the network 206. The input interface 208 is connected to the input devices of keyboard 211 and mouse 212. The output interface 207 is connected to an output device of a monitor 210. A CPU bus 209 includes an address bus, a data bus, and a control bus. The CPU bus 209 is connected to the input interface 208, the output interface 207, the network interface 205, the CPU 201, the ROM 202, the RAM 204, and the storage apparatus 203. In the present exemplary embodiment, an information processing program code including the subject matter of the present disclosure is stored in the storage apparatus 203, and data input via the keyboard 211 and the mouse 212 to be executed by the CPU 201 is stored in the RAM 204 via the input interface 208. In addition, data supplied via the network 206 is placed in the RAM 204 via the network interface 205. The CPU 201 recognizes and analyzes the contents in the RAM 204 based on the control programs. The analyzed result is transmitted to other apparatuses via the monitor 210 and the network interface 205 and the network 206 and via the RAM 204 and the storage apparatus 203 as needed. Note that the monitor 210, the keyboard 211, and the mouse 212 may not necessarily be connected to the apparatuses in the cloud all the time.

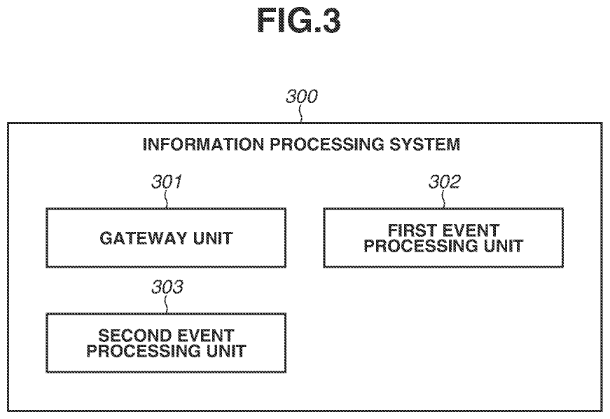

FIG. 3 is a diagram illustrating a module configuration of the information processing system 300 according to the preferred exemplary embodiment of the present disclosure. The information processing system 300 is a system that operates in the cloud service 104. The information processing system 300 includes a gateway unit 301, a first event processing unit 302, and a second event processing unit 303.

In the present exemplary embodiment, the event issuer is the PC 102. The PC 102 receives and displays the result of processing by the information processing system 300 in the cloud service 104 in response to the event issuance.

When the event issued by the PC 102 reaches the cloud service 104 via the Internet 103, the gateway unit 301 first accepts the event. The gateway unit 301 acquires the resource use state of a unit used in the system operating on the cloud service 104 and which cannot be scaled out. The gateway unit 301 determines whether to execute the event by scaling out based on the acquired resource use state. In a case where the gateway unit 301 determines to execute the event by scaling out, the gateway unit 301 creates an execution environment and prepares an application to operate in the created execution environment in an operable state. The execution environment is activated in this way. It should be noted that a plurality of execution environments can be activated, and, for example, up to a preset predetermined number of execution environment can be activated simultaneously. When the first event processing unit 302 becomes capable of executing an event, the gateway unit 301 requests the first event processing unit 302 to process the event. The first event processing unit 302 is a processing unit that performs processing corresponding to the event, and is implemented by a server-less application or the like. The first event processing unit 302 makes an operation request to the second event processing unit 303, which is a service that cannot be scaled out. More specifically, the second event processing unit 303 is a relational database. The relational database cannot be scaled out, but can be scaled up. However, it is difficult to respond flexibly and promptly to an increase in requests by scaling up the relational database. The second event processing unit 303 receives the operation request and returns the result of processing to the first event processing unit 302. The first event processing unit 302 receives the result and returns the result to the event issuer PC 102. If the gateway unit 301 determines not to execute the event, the gateway unit 301 returns the result of the inexecution to the event issuer PC 102.

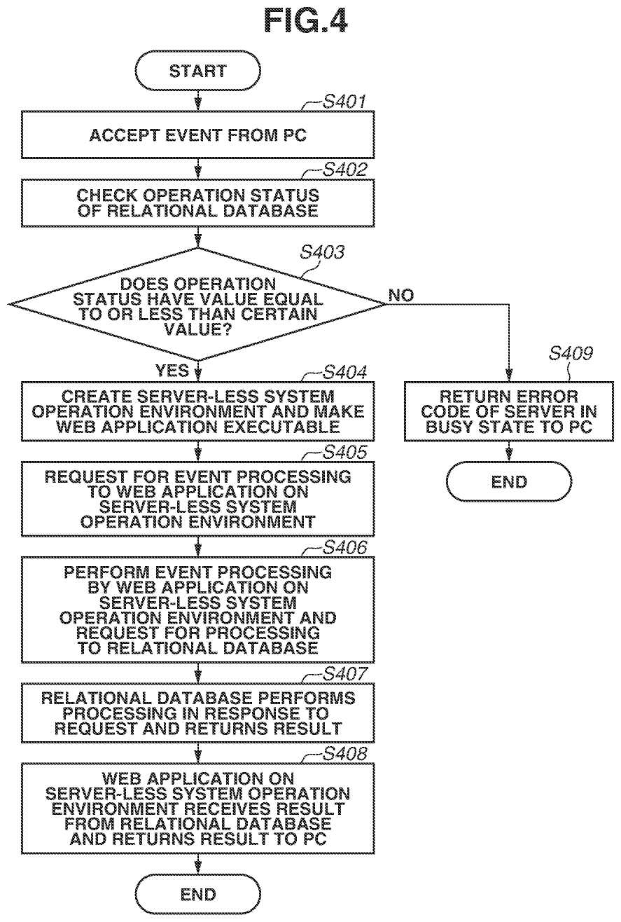

FIG. 4 is a processing flowchart according to the preferred exemplary embodiment of the present disclosure.

An example of the processing flow in response to an event received from the PC 102 will be described in detail below with reference to FIG. 4.

The gateway unit 301 receives the event from the browser in the PC 102 at step S401 in FIG. 4. An event is a term that generally refers to operation requests to the information processing system 300, such as “registration of printing apparatus” and “registration of customer information”. In the present exemplary embodiment, the protocol used in the event is http(s), and data is transmitted together with methods such as GET/POST/PUT/DELETE. Then, the processing proceeds to step S402.

In step S402, the gateway unit 301 checks the operation status of the relational database. Specifically, the gateway unit 301 acquires the operation rate of the database by using a monitoring service or the like. In the present exemplary embodiment, the operation status refers to the operation rate such as the CPU usage rate and the memory usage rate with respect to the processing capability of the database. A relational database is a service that cannot be scaled out and is used for the processing of the event. Then, the processing proceeds to step S403.

In step S403, the gateway unit 301 determines whether the operation status of the relational database is equal to or less than a certain value. In the present exemplary embodiment, for example, in a case where the CPU usage rate is 90% or less and the memory usage rate is 90% or less, the gateway unit 301 determines that there is a surplus in the operation status (YES in step S403), and the processing proceeds to step S404. In a case where the CPU usage rate is greater than 90% or the memory usage rate is greater than 90%, the gateway unit 301 determines that the operation status is tight (NO in step S403), and the processing proceeds to step S409.

In step S409, the gateway unit 301 returns a response that the server is in a busy state and cannot perform processing. In the present exemplary embodiment, the gateway unit 301 returns an http status code 503 (Service Unavailable) to the browser of the PC 102. The browser of the PC 102 displays a screen and a message corresponding to the status code.

In step S404, the gateway unit 301 activates the execution environment and prepares for execution of the Web application which is the first event processing unit 302 so that the Web application is in an executable state, and the processing proceeds to step S405. In relation to the present exemplary embodiment, an example of using a server-less system as the execution environment of the Web application will be described. There are various methods for executing the server-less system, but in the present exemplary embodiment, in step S404, the gateway unit 301 prepares the execution context of function of the server-less system that was prepared in advance via application programming interface (API) Gateway.

In step S405, the gateway unit 301 requests the execution of the Web application which is the first event processing unit 302 in the executable state, and the processing proceeds to step S406. In the present exemplary embodiment, in step S405, the gateway unit 301 calls the function of the server-less system for which the execution context was prepared from API Gateway, and passes the event data.

In step S406, the first event processing unit 302 performs predetermined processing based on the event data, and the processing proceeds to step S407. The predetermined processing includes checking input data, processing data, registering data in a database, data updating, data deleting, data querying, and creating result data such as processing of data acquired from a database. In step S406, the first event processing unit 302 requests the second event processing unit 303 for performing processing during predetermined processing. In the present exemplary embodiment, the second event processing unit 303 is a relational database. The first event processing unit 302 requests processing such as registration (insert), updating (update), deletion (delete), search (select) to the relational database using structured query language (SQL) statements or the like, and the processing proceeds to step S407.

In step S407, the second event processing unit 303 receives the request of SQL statement or the like, executes the processing of SQL statement or the like, and returns the processing result to the first event processing unit 302, and the processing proceeds to step S408. In step S408, the first event processing unit 302 receives the processing result of the second event processing unit 303, and returns the result to the browser in the event issuer PC 102. The browser of the PC 102 displays a screen and a message corresponding to the result.

The relational database described as a service that cannot be scaled out in the present exemplary embodiment is, for example, Amazon RDS (registered trademark) in the AWS (registered trademark) cloud service. The Web application described as a service that can be scaled out in the present exemplary embodiment is, for example, AWS Lambda (registered trademark), which is a server-less system in the AWS (registered trademark) cloud service.

As other services that can be scaled out, Web applications that can be scaled out and operate on AWS Fargate (registered trademark) or EC2 (registered trademark) are also preferred. In addition, there are Microsoft Azure (registered trademark) and the like as cloud services, and it is preferable to utilize these services. In Azure (registered trademark), services that can be scaled out include Virtual Machines (registered trademark), Azure Functions (registered trademark), and Azure Container Instances (registered trademark). It is also preferable to use these services. In Azure (registered trademark), there is Azure SQL Database (registered trademark) as a service that cannot be scaled out, and it is also preferable to use this service.

By the above processing, it is determined whether scale-out can be executed based on the resource use state of the unit that cannot be scaled out, before accepting the event and processing the event by executing scale-out. In a case where it is determined to perform the processing, the event is processed by scaling out. In a case where it is determined not to perform the processing, processing non-execution processing is performed in which no scale-out is performed and no event processing is performed. As described above, it is possible to prevent excessive operation requests exceeding the resource capacity for services that cannot be scaled out, and reduce the risk of system errors.

It should be noted that the service unit that can be scaled out is scaled out within the range of the lower limit and the upper limit of the number of scales by setting a general auto scale. However, such a simple auto scale setting does not take into account the resource use state of services that cannot be scaled out. Therefore, it is not possible to prevent excessive operation requests exceeding the resource capacity for services that cannot be scaled out.

Next, a second exemplary embodiment will be described. A configuration of the second exemplary embodiment conforms to that of the first exemplary embodiment.

In the first exemplary embodiment, the event issuer is the PC 102. The PC 102 receives and displays the result of processing by the information processing system 300 in the cloud service 104 in response to the event issuance. In the present exemplary embodiment, the event issuer is a printing apparatus 101. An event issued from the printing apparatus 101 is processed by an information processing system 300 in a cloud service 104, but the result is not returned to the printing apparatus 101. That is, interactive (synchronous) processing is performed in the first exemplary embodiment, whereas non-interactive (asynchronous) processing is performed in the present exemplary embodiment. Hereinafter, the differences between the present exemplary embodiment and the first exemplary embodiment will be described in detail.

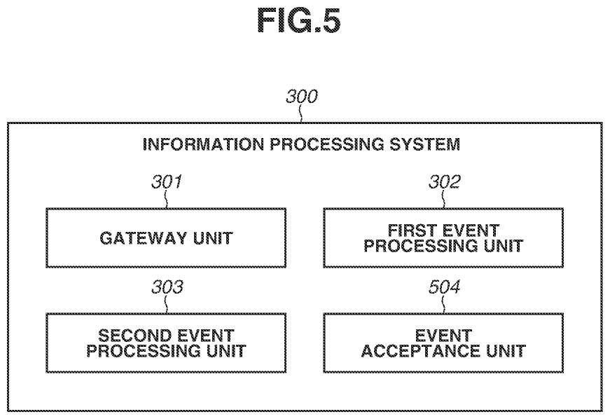

FIG. 5 is a diagram illustrating a module configuration of the information processing system 300 according to the preferred exemplary embodiment of the present disclosure. In addition to the configuration of the first exemplary embodiment, an event acceptance unit 504 that accepts an event issued by the printing apparatus 101 and registers it in a queue is newly added. The event acceptance unit 504 may include a load sharing device.

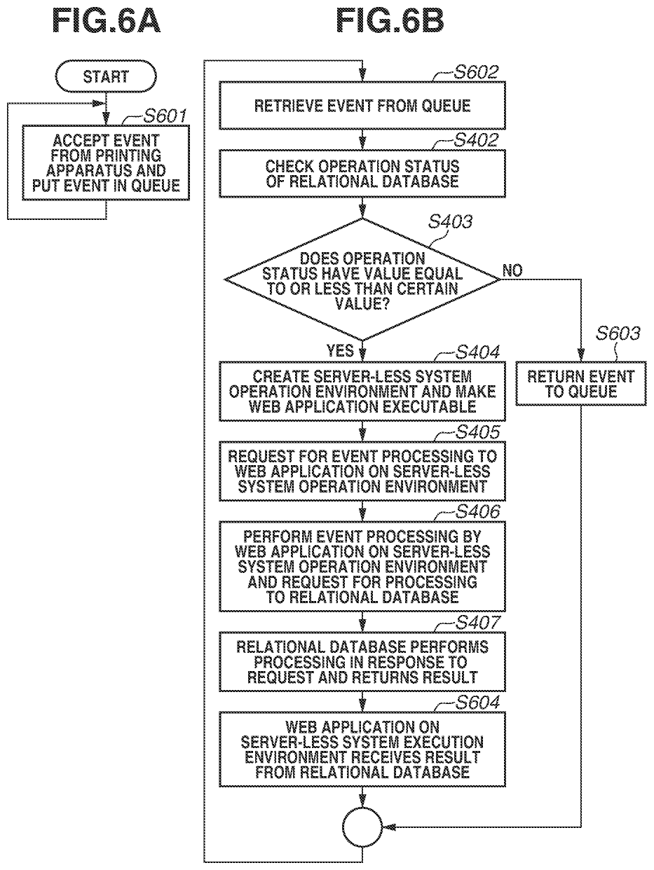

FIGS. 6A and 6B are processing flowcharts according to the preferred exemplary embodiment of the present disclosure.

Hereinafter, an example of a processing flow of accepting an event from the printing apparatus 101 and storing it in the queue will be described with reference to FIG. 6A.

In step S601, the event acceptance unit 504 receives the event issued by the printing apparatus 101 and stores it in a message queue management service (hereinafter referred to as “queue”) (not shown). This processing is always activated to accept events.

An example of the flow of processing an event stored in the queue will be described below with reference to FIG. 6B. In step S602, the gateway unit 301 retrieves the event from the queue, and the processing proceeds to step S402.

In step S402, the gateway unit 301 performs the same processing as in the first exemplary embodiment, and the processing proceeds to step S403. In step S403, the gateway unit 301 determines whether the operation status of the relational database is equal to or less than a certain value. In a case where the gateway unit 301 determines that there is a surplus in the operation status (YES in step S403), the processing proceeds to step S404. In a case where the gateway unit 301 determines that there is no spare capacity in the operation status (NO in step S403), the processing proceeds to step S603. The details of the determination are the same as those in the first exemplary embodiment.

In step S603, the gateway unit 301 returns the event acquired in step S602 to the queue, and the processing proceeds to step S602. In step S603, the gateway unit 301 does not necessarily have to return the acquired event to the queue. Specifically, the gateway unit 301 is prevented from issuing an instruction for deleting the acquired event from the queue. As a result, the event that has been acquired from the queue and has been invisible for a certain period of time returns from the invisible state to the visible state, so that the processing by the first event processing unit becomes possible.

It is also preferable that the gateway unit 301 returns the event to the simple queue service (SQS) of the event in step S603 and waits for a certain period of time, and then the processing proceeds to step S602.

Steps S404 to S407 are the same steps as those in the first exemplary embodiment.

In step S408, the first event processing unit 302 receives the processing result of the second event processing unit 303, and the processing proceeds to step S602.

The message queue management service is, for example, Amazon SQS (registered trademark) in the AWS (registered trademark) cloud service.

Accordingly, even in an event in which asynchronous processing is performed, it is possible to prevent excessive operation requests exceeding the resource capacity for services that cannot be scaled out, and reduce the risk of system errors.

Next, a third exemplary embodiment will be described. A configuration of the third exemplary embodiment conforms to that of the second exemplary embodiment.

In the first and second exemplary embodiments, it is determined whether to execute a service that cannot be scaled out, by the value of the operation status. In the present exemplary embodiment, the importance of an event is calculated, and it is determined whether to execute the event in accordance with the value of the operation status and the importance.

Hereinafter, the third exemplary embodiment will be described in detail with reference to the drawings.

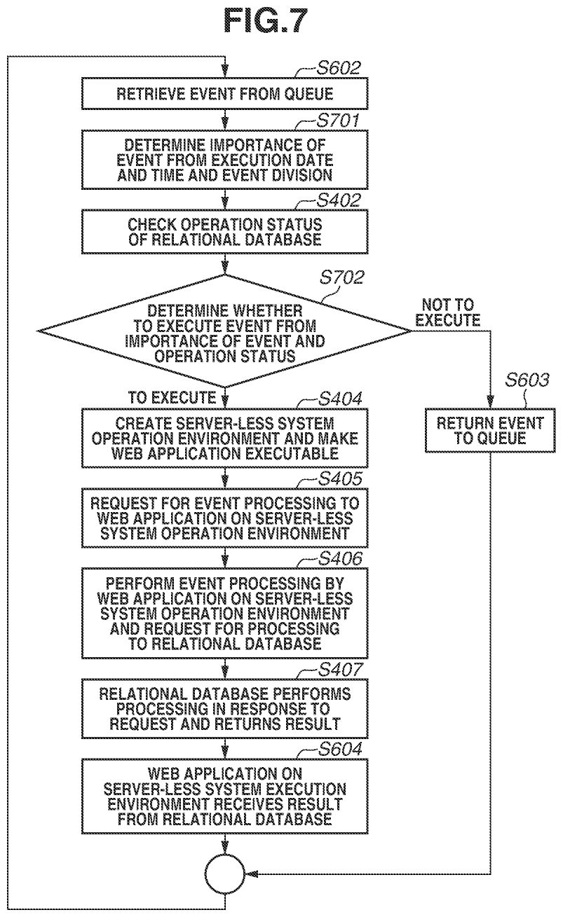

FIGS. 6A and 7 are processing flowcharts according to the preferred exemplary embodiment of the present disclosure. The process of FIG. 6A is the same as that of the second exemplary embodiment. An example of the flow of processing with the importance of an event stored in the queue taken into consideration will be described with reference to FIG. 7.

In step S602, the gateway unit 301 performs the same processing as in the second exemplary embodiment, and the processing proceeds to step S701.

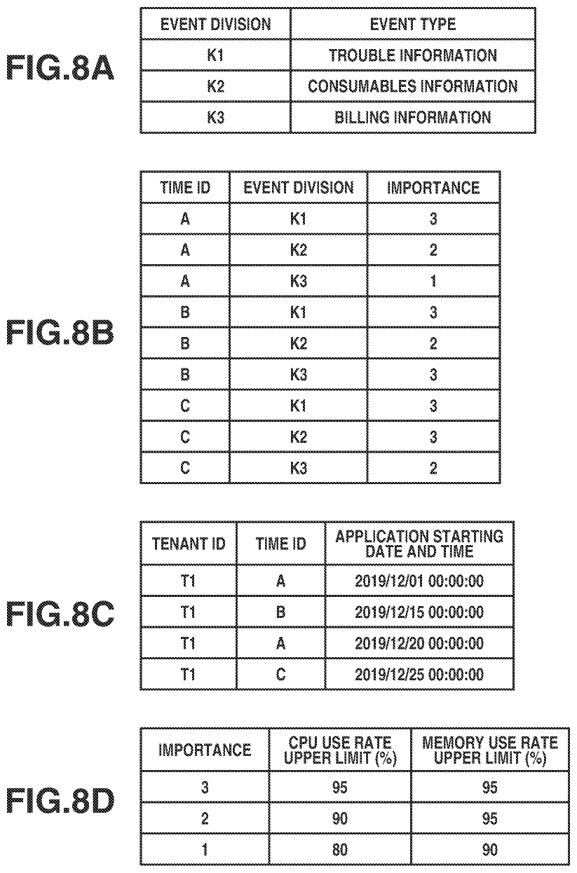

In step S701, the gateway unit 301 determines the importance of the event, and the processing proceeds to step S402. The method of determining the importance of the event in step S701 will be described in detail below using data examples shown in FIGS. 8A to 8D.

The data example in FIG. 8A consists of event divisions and event types. In the present exemplary embodiment, an event always holds an event division, and the type of the event can be found by searching the event divisions of FIG. 8A in the event division of the event. Specifically, if an event has an event division “K1”, the event belongs to “trouble information”. The data example in FIG. 8B consists of time IDs, event divisions, and importances. The event division is as described above, and the importance represents how important the event division is. In the present exemplary embodiment, the importance “3” is the highest, and the subsequent importances “2” and “1” are lower in descending order. The time ID is obtained from the data example shown in FIG. 8C described below and the execution date and time when this processing is to be executed. The data example in FIG. 8C consists of tenant IDs, time IDs, and application starting dates and times. The tenant ID is an ID that represents a multi-tenant in a cloud service, that is, a company/organization that uses an information processing system. In the present exemplary embodiment, only “T1” is used as the tenant ID, but it is also preferable to use a plurality of tenants. The method of obtaining the time ID in the data example of FIG. 8C will be described below. The execution date and time when the processing was executed is compared with the application starting date and time, and the line of the application starting date and time with the largest value that is smaller than the execution date and time is searched from the data example of FIG. 8C to obtain the time ID. For example, if the value of the execution date and time of this processing is “2019/12/03 14; 45:10”, the value of the application starting date and time is “2019/12/01 00:00:00” or higher and “2019/12/15 00:00:00” or smaller, and thus the time ID is “A”. Returning to the data example shown in FIG. 8B, in the present exemplary embodiment, since the time ID is “A”, the importance of the event division “K1” is “3”. In a case where the importance is calculated by the same time ID, the importance of the event division “K2” is “2” and the importance of the event division “K3” is “1”.

In step S402, the gateway unit 301 performs the same processing as in the first exemplary embodiment, and the processing proceeds to step S702. In step S702, the gateway unit 301 determines whether the processing can be executed based on the operation status of the relational database and the importance of the processing target event. In the present exemplary embodiment, the determination uses the data example of FIG. 8D. The data example in FIG. 8D consists of importances, CPU use rate upper limits (%), and memory use rate upper limits (%). In a case where the importance is “3”, the CPU use rate upper limit (%) is “95” and the memory use rate upper limit (%) is “95”. That is, in a case where the importance is “3”, the gateway unit 301 determines that the processing can be executed if the CPU use rate is “95”% or less and the memory use rate is “95”% or less. In a case where the gateway unit 301 determines that the processing is executable (YES in step S702), the processing proceeds to step S404. If the importance is “3” and the CPU use rate is greater than “95”% or the memory use rate is greater than “95”%, the gateway unit 301 determines that the processing cannot be executed, that is, the processing is not to be executed. In a case where the gateway unit 301 determines that the processing is not to be executed (NO in step S702), the processing proceeds to step S603. Step S603 and steps S404 to S407 to S604 are the same as those of the second exemplary embodiment.

As described above, by controlling the operation request for the service that cannot be scaled out with the importance of the event taken into consideration, it is possible to preferentially use the limited resources for the processing having higher importance. As a result, resources can be used more effectively.

In addition, since the importance of the event division can be changed depending on the time, it is possible, for example, to usually set the importance of an event of trouble information to be high and set the importance of an event of billing information to be low, and increase the importance of the event of billing information near the cutoff date of the billing.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-023485, filed Feb. 14, 2020, which is hereby incorporated by reference herein in its entirety.

What is claimed is:

1. An information processing system that includes an acceptance unit configured to accept an event from an external apparatus and a database to which a processing result of the accepted event is to be written, the information processing system comprising:
one or more processors; and
at least one memory storing instructions, which when executed by the one or more processors, cause the information processing system to:
check an operation rate of the database upon acceptance of the event from the external apparatus;
determine whether to process the event accepted from the external apparatus based on the checked operation rate of the database; and
activate a processing unit to execute the processing of the event in a case where it is determined to process the accepted event,
wherein activation of a plurality of the processing units is executable, and
wherein the activated processing unit executes the processing of the event and writes the processing result of the event to the database.

2. The information processing system according to claim 1,
wherein the instructions, when executed by the one or more processors, further cause the information processing system to:
determine an importance of the event based on at least a type of the accepted event, and
wherein it is determined whether to process the event based on the determined importance of the event and the checked operation rate of the database.

3. The information processing system according to claim 1, wherein the acceptance unit is a queue for storing events from the external apparatus.

4. The information processing system according to claim 1, wherein the database cannot be scaled out.

5. A control method of an information processing system that includes an acceptance unit configured to accept an event from an external apparatus and a database to which a processing result of the accepted event is to be written, the control method comprising:
checking an operation rate of the database upon acceptance of the event from the external apparatus;
determining whether to process the event accepted from the external apparatus based on the checked operation rate of the database; and
activating a processing unit to execute the processing of the event in a case where it is determined to process the accepted event,
wherein activation of a plurality of the processing units is executable, and
wherein the activated processing unit executes the processing of the event and writes the processing result of the event to the database.
